(19) United States
(12) Patent Application Publication
(10) Pub. No.: US 2023/0127701 A1
(43) Pub. Date: Apr. 27, 2023

(54) QUESTION-ANSWER-BASED CONTENT SHARING METHOD AND SYSTEM

(71) Applicant: BMCAMP INC., Seoul (KR)

(72) Inventor: Seung Hwan VAN, Seoul (KR)

(21) Appl. No.: 17/910,266

(22) PCT Filed: Apr. 30, 2020
(86) PCT No.: PCT/KR2020/005819

§ 371 Date: Sep. 8, 2022

(30) Foreign Application Priority Data
Mar. 11, 2020 (KR) 10-2020-0030457

(51) Int. Cl. G06F 40/134; H04L 51/08

(52) U.S. Cl. CPC G06F 40/134; H04L 51/08

(57) ABSTRACT

A question-answer-based content sharing method includes: a first step of inputting and storing a question, an answer, and a content in a server through a question-answer creation image included in a transmitter terminal GUI; a second step of creating a web page including an answer input window and a question solution image; a third step of creating a question-answer link connected with a web page address created in the second step; a fourth step of opening the question-answer link created in the third step; a fifth step of displaying the question solution image on a receiver terminal GUI connecting with the question-answer link; and a sixth step of outputting the content input in the first step to the receiver terminal GUI when an answer input in the question solution image displayed in the fifth step coincides with the answer input in the first step.

### BACKGROUND OF THE INVENTION

### Field of the Invention

An embodiment of the present disclosure relates to a question-answer-based content sharing method and system.

### Description of the Related Art

As the internet environment and technologies related to mobile devices have made great strides, various methods of reading and sharing contents are being developed and user can give/receive and share various files such as sounds, pictures, videos, and documents as contents.

Recently, users and the use range of acquaintance-based social network services (SNS) are increasing. The acquaintance-based SNSs are, in many cases, operated in the way that when any one user posts his/her normal life, the post is automatically exposed to acquaintances of the user and acquaintances who read the post click “thumbs up” or make a comment, and Facebook may be representative of such SNSs.

Meanwhile, people with different properties such as friends, family, and coworkers are mixed in the “acquaintance” in such acquaintance-based SNSs, and as a result, there is a problem that it is difficult to manage the share range of posts. Accordingly, posts that a user make are exposed simultaneously to various types of people in some cases, and depending on cases, a very awkward and uncomfortable situation may be caused. Of course, when acquaintances are discriminated in accordance with personalities and the share range of a post is thoroughly managed, it is possible to reduce a problem that a predetermined post is shared by acquaintances with which a user does not want to share the post. However, it is not easy like saying to severely classify groups of many acquaintances in the modern life that goes fast every moment and to adjust every exposure range in accordance with the characteristics of posts, and the larger the number of acquaintances or posts, the severe this problem unavoidably gets.

Further, the case in which the members of family share devices such as a smartphone and a tablet PC or coworkers use the devices together is gradually increasing. In this situation, as contents including secret or sensitive private matters are frequently exposed to other users who commonly use smart devices such as the members of family or coworkers, a reform measure is required.

### SUMMARY OF THE INVENTION

An aspect of the present disclosure can provide a question-answer-based content sharing method that enables a user to read a reading-limited content or communicate with a specific person on line even though the user does not provide identification information on line.

An aspect of the present disclosure can provide a question-answer-based content sharing method that uses the existing post opening type and enables only limited acquaintances whom a user wants to read a content.

An aspect of the present disclosure can provide a question-answer-based content sharing method that can enhance security in information transmission and a privacy protection function.

An aspect of the present disclosure can provide a question-answer-based content sharing method that can inject fresh vigor to the normal life by making a user look back on memories or have an interest.

An aspect of the present disclosure can provide a question-answer-based content sharing system that enables a user to read a content or communicate with other people on line even though the user does not provide identification information.

An aspect of the present disclosure can provide a question-answer-based content sharing system that uses the existing post opening type and enables only limited acquaintances whom a user wants to read a content.

An aspect of the present disclosure can provide a question-answer-based content sharing system that can enhance security in information transmission and a privacy protection function.

An aspect of the present disclosure can provide a question-answer-based content sharing system that can inject fresh vigor to the normal life by making a user look back on the past or have an interest.

A question-answer-based content sharing method according to an exemplary embodiment of the present disclosure includes: a first step of inputting and storing a question, an answer, and a content in a server through a question-answer creation image included in a transmitter terminal GUI; a second step of creating a web page including an answer input window and a question solution image in which the question input in the first step is displayed; a third step of creating a question-answer link connected with a web page address created in the second step; a fourth step of opening the question-answer link created in the third step; a fifth step of displaying the question solution image on a receiver terminal GUI connecting with the question-answer link opened in the fourth step; and a sixth step of outputting the content input in the first step to the receiver terminal GUI when an answer input in the question solution image displayed in the fifth step coincides with the answer input in the first step.

In this case, the receiver may be a user who did not provide individual identification information to a service of the server.

Further, in this case, the transmitter may be a user who provided individual identification information to a service of the server.

Further, the receiver may be a non-member who didn't join a service of the server and the transmitter may be a member who joined a service of the server.

Further, a chat window may be displayed on the receiver terminal GUI in the sixth step, and the chat window may display a chat room in which a transmitter who created a question-answer link using the transmitter terminal GUI and a receiver who input a correct answer using the receiver terminal GUI are participants.

Further, when the receiver inputs a correct answer, a toke is issued to a receiver terminal, and the chat room may be set up by creating a chat session using a token of the transmitter and a token of the receiver terminal.

Further, a comment window may be displayed on the receiver terminal GUI in the sixth step, and a transmitter who created a question-answer link using the transmitter terminal GUI and a receiver who input a correct answer using the receiver terminal GUI can input a comment in the comment window.

Further, the question-answer link may be input and opened in an operating service of at least one service selected from a common web board service, a social network service, and a messenger service.

Further, a step of setting a range of the opening in the fourth step may be further included.

Further, the server may include at least one or more of a password checking module, location information checking module, a time information checking module, a period information checking module, a sound information checking module, a sound-language conversion module, a payment information checking module, a text information checking module, a handwriting input module, an image-language conversion module, a color information checking module, an exercise information checking module, and a number-of-time information checking module.

Further, the question and answer type may include at least one type of a simple text type, a location range type, a charged item payment type, a handwriting input type, an App download request type, an objective selection type, and a target payment amount satisfaction type; the question and answer type may include a predetermined website membership joining option; and the server may determine whether login to the predetermined website succeeded.

Further, the question-answer link may be converted into a QR code, the QR code may be attached to at least one of a card, a target, a table, and a building, and the receiver terminal may decode the QR code and access the receiver terminal GUI.

Further, the question and answer type may include at least one type of a simple text type, a location range type, a charged item payment type, a handwriting input type, an App download request type, an objective selection type, and a target payment amount satisfaction type; the question and answer type may include an N-time order-of-receipt option; and the server may stop opening the content after a correct answer to the question is confirmed N times.

A question-answer-based content sharing system according to an exemplary embodiment of the present disclosure may include: a transmitter terminal connected to the server through a transmitter terminal GUI; a receiver terminal connected to the server through a receiver terminal GUI; and a correct answer checker configured to check whether an answer that is input in the question solution image is a correct answer.

In this case, the correct answer checker may include a number-of-time information checking module configured to detect whether a correct answer to the question was confirmed N times, and the server may stop opening the content after a correct answer to the question is confirmed N times.

According to an embodiment of the present disclosure, it is possible to provide a useful effect that a user can read a reading-limited content or communicate with people on line even though the user does not provide identification information on line such as his/her phone number, email address, and ID. Further, even a user who does not have identification information stored in a server can read a reading-limited content or communicate with people on line.

According to an embodiment of the present disclosure, it is possible to provide a useful effect that it is possible to use the existing post opening type, the existing acquaintance-based SNS post management method, and the existing messenger service management method and to enable only limited acquaintances whom a user wants to read a content.

Further, it is possible to give limitation such that only specific users can read or share a content included in a post made on a common web page without limitation in access. Further, since a content can be shared only to acquaintances who know a question and an answer even without individually setting an opening range for each post even in an acquaintance-based SNS such as Facebook.

According to an embodiment of the present disclosure, it is possible to open only a portion of a post and open the actual details to only specific people or specific group that a user wants through an on-line or off-line medium that is almost not limited in access through a question and an answer that a predetermined counterpart and a transmitter who want to share a content know.

According to an embodiment of the present disclosure, it is possible to provide a useful effect that it is possible to enhance security in information transmission and a privacy protection function.

Further, it is possible to make a user look back on the past memories or have an interest through a process of solving a problem using predetermined clues, and it is possible to improve ties in personal relationship such as lover relationship, friend relationship, and family relationship. Similarly, when the present disclosure is applied to a fan letter between a star such as an entertainer and a fan, the present disclosure provides a useful effect that it is possible to improve ties between an entertainer and a fan, improve satisfaction of fans, and make a profit.

### BRIEF DESCRIPTION OF THE DRAWINGS

FIG. 1 is a diagram for describing a question-answer-based content sharing system according to an embodiment of the present disclosure;

FIG. 2 is a diagram for describing a question-answer-based content sharing method according to an embodiment of the present disclosure;

FIG. 3 is a diagram for describing a question-answer-based content sharing method according to an embodiment of the present disclosure;

FIG. 4 is a diagram for describing a question-answer-based content sharing method according to another embodiment of the present disclosure;

FIG. 5 is a diagram for describing a method of selecting a question-answer type according to an embodiment of the present disclosure;

FIG. 6 is a diagram for describing a method of selecting a question-answer type according to another embodiment of the present disclosure;

FIG. 7 is a flowchart for describing a question-answer-based content sharing method according to an embodiment of the present disclosure;

FIG. 8 is a diagram for describing a post list image of a forum according to an embodiment of the present disclosure;

FIG. 9 is a diagram for describing the detail of a post according to an embodiment of the present disclosure;

FIG. 10 is a diagram for describing a post list image of a forum according to another embodiment of the present disclosure;

FIG. 11 is a block diagram schematically exemplifying a server of a question-answer-based content sharing system according to an embodiment of the present disclosure; and

FIG. 12 is a block diagram schematically showing a correct answer checker according to an embodiment of the present disclosure.

### DETAILED DESCRIPTION OF THE INVENTION

Hereinafter, exemplary embodiments of the present disclosure will be described in detail with reference to the accompanying drawings.

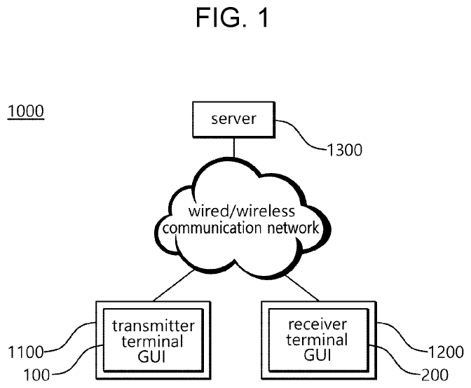

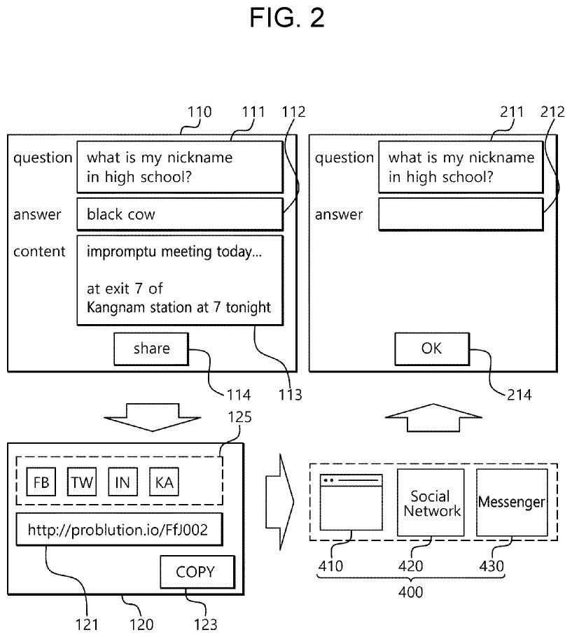

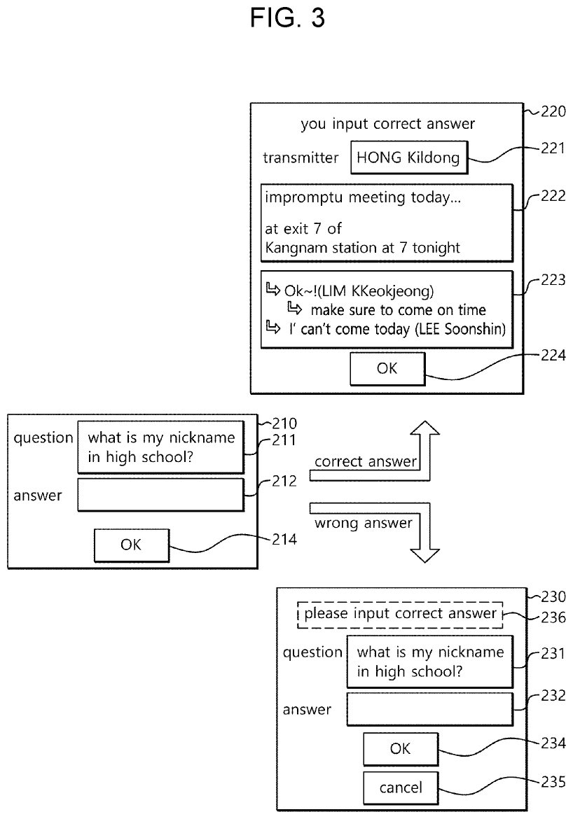

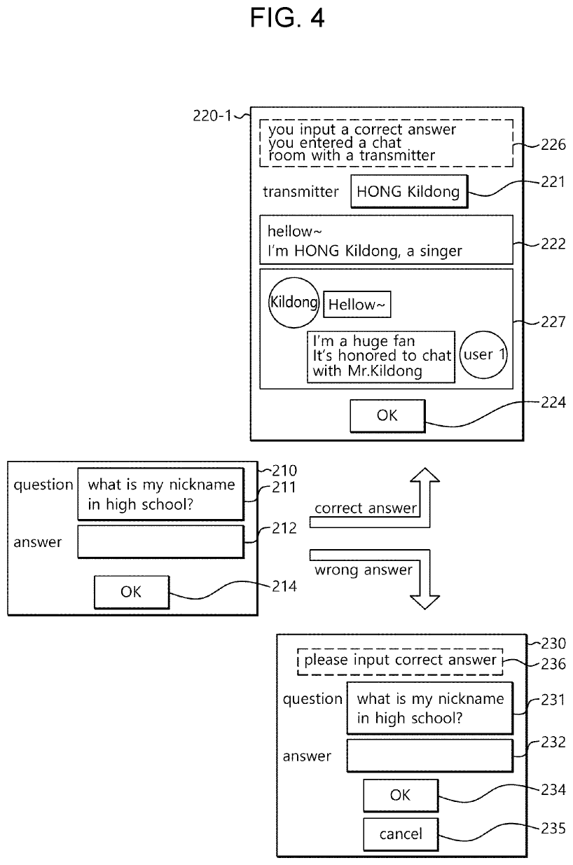

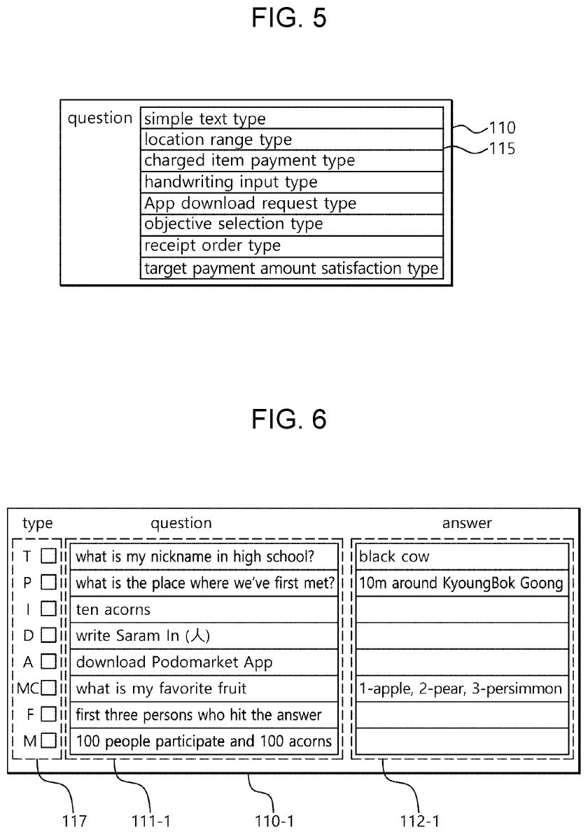

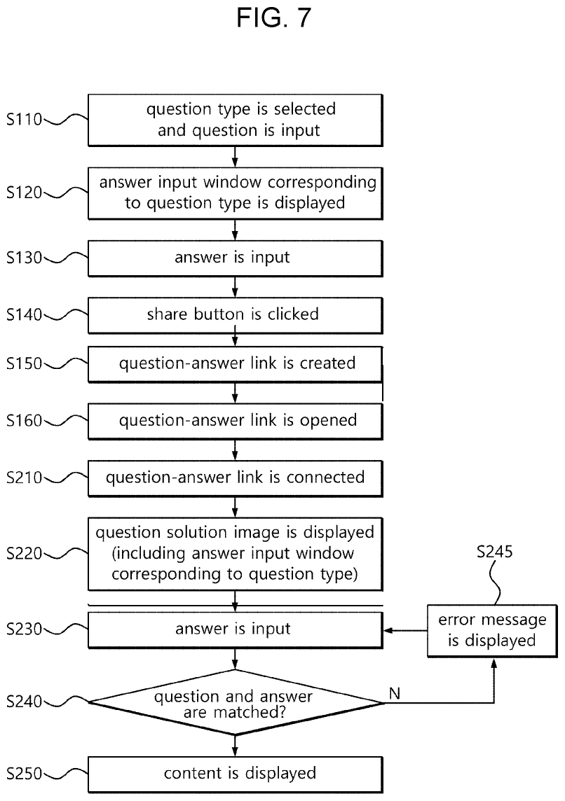

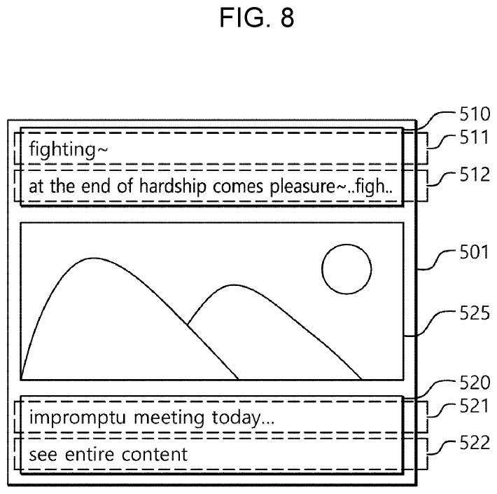

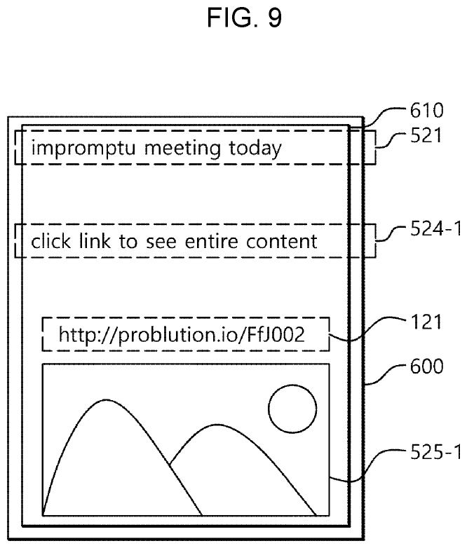

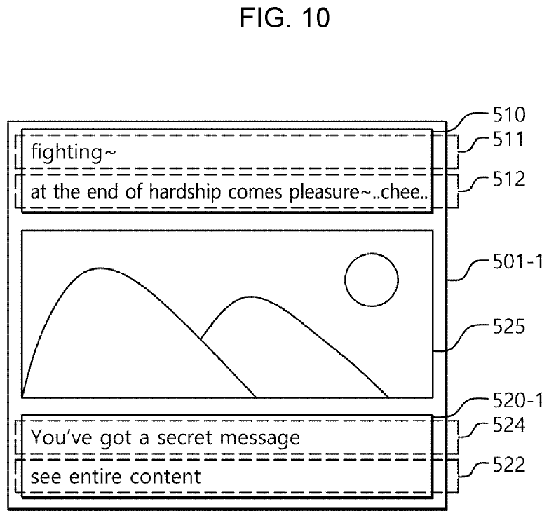

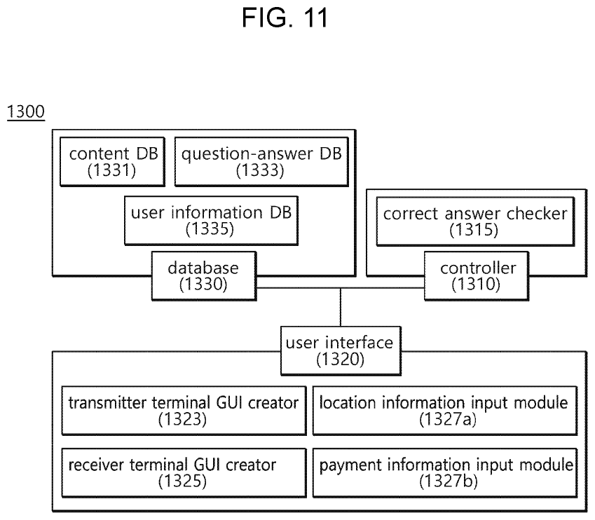

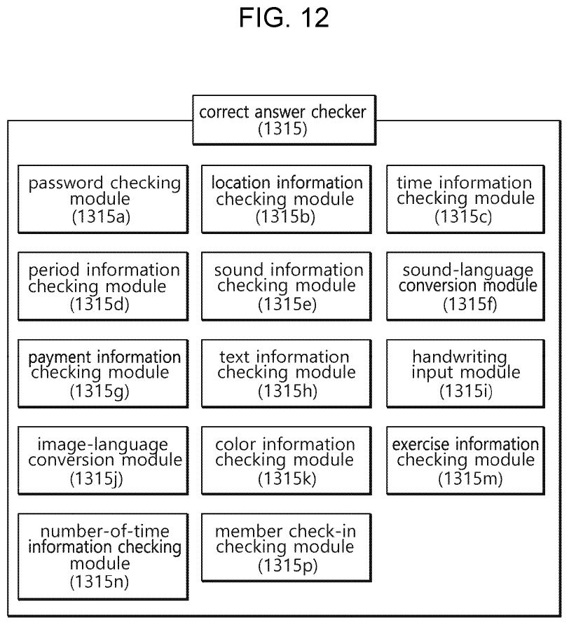

FIG. 1 is a diagram for describing a question-answer-based content sharing system according to an embodiment of the present disclosure, FIG. 2 is a diagram for describing a question-answer-based content sharing method according to an embodiment of the present disclosure, FIG. 3 is a diagram for describing a question-answer-based content sharing method according to an embodiment of the present disclosure, FIG. 4 is a diagram for describing a question-answer-based content sharing method according to another embodiment of the present disclosure, FIG. 5 is a diagram for describing a method of selecting a question-answer type according to an embodiment of the present disclosure, FIG. 6 is a diagram for describing a method of selecting a question-answer type according to another embodiment of the present disclosure, FIG. 7 is a flowchart for describing a question-answer-based content sharing method according to an embodiment of the present disclosure, FIG. 8 is a diagram for describing a post list image of a forum according to an embodiment of the present disclosure, FIG. 9 is a diagram for describing the detail of a post according to an embodiment of the present disclosure, FIG. 10 is a diagram for describing a post list image of a forum according to another embodiment of the present disclosure, FIG. 11 is a block diagram schematically exemplifying a sever 300 of a question-answer-based content sharing system according to an embodiment of the present disclosure, and FIG. 12 is a block diagram schematically showing a correct answer checker according to an embodiment of the present disclosure.

A question-answer-based content sharing system according to an embodiment of the present disclosure may include a transmitter terminal 1100, a receiver terminal 1200, and a server 1300. In an embodiment, a transmitter terminal GUI 100 and a receiver terminal GUI 200 created by the server 1300 can be displayed on the transmitter terminal 1100 and the receiver terminal 1200, respectively.

In an embodiment, a transmitter and a receiver can connect with a service web page provided by the server 1300 by executing web browsers installed in the terminals 1100 and 1200, respectively. The service web page may be driven in a way similar to common internet web pages, a graphic element through which it is possible to select whether it is possible to use a question-answer function may be included in the service web page, and when the graphic element is clicked, a question-answer creation image 110 may be displayed.

A question-answer-based content sharing method according to an embodiment of the present disclosure may be configured such that a question, an answer, and a content are input through the transmitter terminal 1100 and stored in the server 1300, a link connecting the stored question and answer is created, the link is opened on an information platform 400, the quest is displayed on the receiver terminal 1200 connecting with the opened link, and the content is output to the receiver terminal 1200 when the answer to the question is a correct answer. In this configuration, the information platform 400 may include a common web board service operating server 410, a social network service operating server 420, and a messenger service operating server 430. Further, the information platform 400 may include most operating servers that service web pages constructed by languages such as SGML, HTML, XML, and XHTML.

In an embodiment, the question-answer creation image 110 may include a question input window 111, an answer input window 112, and a content input window 113. The question-answer creation image 110 may be displayed on a transmitter terminal GUI 100 that is displayed on the transmitter terminal 110. When a question, an answer, and a content are input through the question-answer creation image 110, the input data can be stored in the server 1300. In an embodiment, the question-answer creation image 110 may further include a share button, and when the share button 114 is clicked after input of a question, an answer, and a content is finished, storing the question, the answer, and the content into the server 1300 can be finished. In this case, not only simple texts, but multimedia files, such as an image, a video, and a sound, or a book, a log file, etc. are stored in the server 1300, and any data that can be transmitted on line and can be read can be read or shared through the question-answer-based content sharing method according to an embodiment of the present disclosure.

In an embodiment, a question and an answer may be made in various types. In an embodiment, questions and answers may be made in any one of a simple text type, a location range type, a charged item payment type, a handwriting input type, an App download request type, an objective selection type, a receipt order type, and a target payment amount satisfaction type.

In an embodiment, a question type is selected and a question is input on the question-answer creation image 110 (S110). Next, an answer input window 112 corresponding to the selected question is displayed (S120). In this case, any one of a character input window, a location information input window, a charged item payment information input window, a handwriting input window, an objective answer input window, a receipt order condition input window, and a target amount payment window is displayed as an answer input window to correspond to the question and the answer type. In an embodiment, a question type selection window 115 exemplified in FIG. 5 may be displayed on the question-answer creation image 110 to select a question type. In another embodiment, as exemplified in FIG. 6, a question-answer creation image 110-1 may be implemented in a way of listing a type selection checkbox 117, a question input window 111-1, and an answer input window 112-1 for each question type.

In an embodiment, a question and an answer may be made in a simple text type. For example, an answer “black cow” may be matched to a question “what's your nickname in high school?”. To this end, the answer input window may be implemented as a character input window.

In an embodiment, a question and an answer may be made in a location range type. For example, an answer to a question “within 100 m around Kyoung Bok Goong” may be that the receiver terminal 1200 is located at a point within a 100 m radius from Kyoung Bok Goong. To this end, the answer input window 112 may be implemented as a location information input window. In an embodiment, the location information input window may be made in a map type and one spot in the map may be set as an answer. In an embodiment, it may be possible to directly input the latitude and longitude coordinates of one spot. Further, it may be possible to set an available range around a set location. In an embodiment, a receiver can check a question of a question solution image 210, find out the spot corresponding to the answer to the question, move the receiver terminal 1200 to the spot, and then click an OK button. In an embodiment, a receiver can solve a problem by selecting a spot corresponding to the question in a map or input a predetermined place name or coordinates into an answer input window.

In an embodiment, a question and an answer may be made in a charged item payment type. For example, an answer to a question of paying ten acorns (an example of a charged item) may be paying ten acorns in the receiver terminal 1200.

In an embodiment, a question and an answer may be made in a handwriting input type. For example, when a handwriting input type is selected and a Chinese character is selected from handwritings, a Chinese character input window through which Chinese characters can be input can be displayed. In this case, the number of Chinese characters may be 1 or more. When a pattern is selected from handwriting types, a pattern input window through the pattern can be input can be displayed.

In an embodiment, the pattern may mean a patter that is drawn by connecting several points and such a pattern is already widely used for android smartphones. Meanwhile, a handwriting input window may be displayed as an answer input window in the receiver terminal GUI 200 that is displayed on the receiver terminal 1200. In an embodiment, it is possible to draw an answer with a hand or a pen in the handwriting input window. For example, it is possible to write and input Chinese characters or input a drawing pattern.

In an embodiment, a question and an answer may be made in an App download request type. For example, the answer to a question of downloading a ‘Podomarket App’ may be downloading a Podomarket App to the receiver terminal 1200. In this case, various methods can be applied to check whether the Podomarket App as downloaded to the receiver terminal 1200. As an example, when the Podomarket App is downloaded and installed, predetermined characters may be displayed in a start image. Next, it is possible to whether the question and the answer are matched by inputting the characters into the answer input window 112 on the receiver terminal 1200.

In an embodiment, a question and an answer may be made in a specific website join request type. For example, the answer to a question that only members of a Podomarket site can answer a question is to connect with the Podomarket site and joint the membership through the receiver terminal 1200. In this case, the sever 1300 according to an embodiment of the present disclosure may be provided with a member check-in function of the Podomarket site, and accordingly, it is possible to check whether member login to the Podomarket in the Podomarket site through the receiver terminal 1200. Next, in order to provide a member check-in function of the Podomarket to the server 1300, it is possible to provide API that enables login to the web server of the Podomarket itself from the outside.

In an embodiment, a question and an answer may be made in an objective type. An answer to a question “which one of 1—apple, 2—pear, and 3—persimmon, which are choices, is my favorite fruit?” may be selected from 1—apple, 2—pear, and 3—persimmon that are choices, and a correct answer checking process may be performed by checking whether an answer set in advance by a transmitter and the answer input by the receiver are matched.

In an embodiment, a question and an answer may be made in a receipt order type. For example, it may be set that only three people can be considered as a correct answer in order of receipt to a question that “what is my nickname in high school”. In this case, steps S110, S120, and S130 of FIG. 7 can be performed by checking type selection checkboxes 117 of a text type T and a receipt order type F and inputting a question and an answer in the question-answer creation image 110-1 of FIG. 6. Accordingly, it is possible to induce an interest or raise the importance of an action of reading a message and only limited people are allowed to check a content in a group chat room, etc. in order of receipt, whereby it is possible to enable people to competitively find out an answer for reading a content, and accordingly, it is possible to induce active participation of participants of a group chat room.

In an embodiment, a question and an answer may be made in a target payment amount satisfaction type. For example, for a question of requesting 100 people to participate and pay 100 acorns, checking a correct answer may be held until 100 receivers participates and 100 acorns are paid. Further, when participation and payment of the target number of people are accumulated and the target is reached, receivers who have participated can be informed of this face and a content reading link can be transmitted to the receivers.

In an embodiment, two or more question types may be combined. For example, it may be set that a question and an answer are matched only when a charged item is paid and then an accurate answer is presented to a text type question. Further, it may also be set that a question and an answer are matched only when a person is identified as a member of a Podomarket site and then an accurate answer is presented to a text type question.

Next, when an answer to a question is input (S130) and all of the items required in the question-answer creation image 110 are input, the input question, answer, and content are stored in the server 1300. Next, when the share button 114 is clicked (S140), a question-answer link 121 is created (S150) and a question-answer link creation image 120 is displayed. In an embodiment, the created question-answer link 121 can be displayed on the question-answer link creation image 120, and a copy button 123, a share path shortcut button 125, etc. may be included in the question-answer link creation image 120. In this case, most services through which contents can be shared from the outside such as Facebook, Twitter, Instagram, Kakao Talk, and Line may be linked to the share path shortcut button 125. In an embodiment, when the share button 114 is clicked, storing a question, an answer, and a content in the server 1300 can be finished, and in this case, a question-answer link 121 can be created. In this case, the content can be input into a content input window 113 of the question-answer creation image 110 before the share button 114 is clicked. That is, a content can be input at any point in time before step S150 described above. Meanwhile, the question-answer link 121 itself may be displayed in the question-answer link creation image 120, but a shortcut address, a representative name, or the like of the question-answer link 121 may be displayed in the question-answer link creation image 120. Further, the question-answer link 121 may not be displayed in the question-answer link creation image 120 and may be copied to a clipboard of the transmitter terminal.

In an embodiment, one link may be defined as a question-answer link 121 in that the link is connected to a pair of question and answer composed of any one question and an answer to the question.

In an embodiment, a question is displayed on the question solution image 210 and an answer input window 212 through which an answer to the question can be input is also displayed on the question solution image 210. In an embodiment, the question solution image 210 is implemented as a kind of web page. A web document file of the question solution image 210 implemented as a web page may be stored in the server 1300.

In an embodiment, the question-answer link 121 may be a link that is connected to a web document of the question solution image 210. In an embodiment, the question-answer link 121 may be implemented as a web address itself of the question solution image 210. In another embodiment, the question-answer link 121 may be implemented as a shortcut address that can be connected with the web address of the question solution image 210.

Next, the question-answer link 121 is opened (S160).

In an embodiment, the question-answer link 121 may be completely opened without limitation. In an embodiment, the question-answer link 121 may be opened on line by inputting the question-answer link 121 to a server 1300 of a common web page, a common web board service, a social network service, a messenger service, etc.

In another embodiment, the question-answer link 121 may be opened only within a preset predetermined range. For example, when a post including the question-answer link 121 is made on a board of a cafe, etc. in which only members can see the detail, the question-answer link 121 is opened only to members of the café. Further, in social network services such as Facebook, the opening range of a post can be classified into a family, friends, coworkers, an other small groups, depending on setting by the owner of the account, and may be completely opened, and the opening range of the question-answer link 121 can be adjusted through this opening range setting method. Further, in messenger services such as Kakao talk, a transmitter creating the question-answer link 121 may input the question-answer link 121 into a chat window with a specific counterpart or may input the question-answer link 121 into a group chat room.

In an embodiment, as exemplified in FIG. 8, a common post 510 and a question-answer link-including post 520 may be arranged in the post list image 501. The common post 510 is usually displayed in the post list image 501 with a title of the post and a detail preview 512 involved with each other. However, in the question-answer link-including post 520 according to an embodiment of the present disclosure, a second link 522 may be displayed with the content preview 521 in the post list image 501. The second link 522 is defined as a meaning of an additional link for the question-answer link 121, and when the second link 522 is clicked, the question solution image 210 can be displayed. In another embodiment, when the second link 522 is clicked, a post image 600 exemplified in FIG. 9 may be displayed. Referring to FIG. 9, in an embodiment, a question-answer link-including post detail 610 is displayed in a post image 600, and a content preview 521, a question-answer notice 524-1, a question-answer link 121, and an image 525-1 may be included in the question-answer link-including post detail 610. It is possible to move on to the next stage by click the question-answer link 121 included in the question-answer link-including post detail 610 or copying and pasting the question-answer link 121 to a web browser.

In an embodiment, as exemplified in FIG. 10, for the question-answer link-including post 520-1, the second link 522 may be displayed with the question-answer content notice 524 in the post list image 501. The second link 522 was described above, so repeated description is omitted.

Meanwhile, identification information of a receiver is not a necessary component in the process of performing the question-answer-based content sharing method according to an embodiment of the present disclosure. That is, it is possible to share or read a content by connecting with a question-answer link or inputting an answer matched with a question using the question-answer-based content sharing method according to an embodiment of the present disclosure even without identification information of a receiver. Accordingly, a receiver does not need to provide any individual identification information that can specific a user such as a name, an ID, a phone number, and an email address, and accordingly, convenience and accessibility in used can be remarkably improved in services to which an embodiment of the present disclosure is applied. In addition, a receiver does not need to join the membership of a service. In other words, even if a receiver provides any individual identification information to a service server, the receiver does not need to join the membership. On the other hand, in an embodiment, a transmitter may necessarily join the membership through a service server.

Further, in the question-answer-based content sharing method according to an embodiment of the present disclosure, many unspecified individuals who do not provide individual identification information may become receivers and attempt to read a content through a question-answer solution process, but even in this case, a transmitter can simply limit the number of times of reading a content, so it can be used for various types of marketing.

Next, referring to FIG. 10, when a receiver connects with a question-answer link 121 open to the information platform 400 (S210), the question solution image 210 connected with the question-answer link 121 is displayed on the receiver terminal GUI 200 (S220). Referring to FIG. 3, the question solution image 210 may include a question display window 211, an answer input window 212, and an OK button 214.

In an embodiment, when an answer is input through the question solution image 210, the server 1300 checks whether the answer is the correct answer by determining whether the input answer is matched with the question (S240). The content is displayed when the answer is the correct answer (S250), but the process may fed back to step S230 when the answer is not the correct answer. In an embodiment, in the content display image 220, a content display window 222 may be included, and a transmitter display window 221, an OK button 224, etc. may be further included. An example in which a question and an answer are made in a text type is shown in FIG. 3, but the present disclosure is not limited thereto. Meanwhile, when an input answer is a wrong answer, an error message may be displayed (S245) and the process may be fed back to step S230. That is, a wrong answer notice image 230 may be displayed on the receiver terminal GUI 200, and a wrong answer notice display window 236, a question display window 231, an answer input window 232, an OK button 234, and a cancel button 235 may be included in the wrong answer notice image 230. In this case, the cancel button can be used to give up solving a question.

In an embodiment, a comment window 223 may be included in the content display image 220. In this case, user's feeling or thought about a content may be input and displayed in a comment type in the comment window 223. Further, even though not related to a content, any thought such as though about a transmitter or a message may be input to the comment window 223 in a comment type. In an embodiment, when a comment is displayed in the comment window 223, a separate alarm may be transmitted to the transmitter terminal 1100. In an embodiment, a receiver who input a correct answer to a question can access the comment window 223. In an embodiment, the opening range of the comment window 223 may be limited such that only specific receivers and transmitters can see the comment window. In another embodiment, the opening range may be limited such that a plurality of receivers who input a correct answer to a question can see the comment window. Meanwhile, the content display window 222 may be left as a blank. That is, even though a specific content is shared, only the comment window 223 may be shared. Further, in this embodiment, only the comment window 223 is included and the content display window 222 may not be included in the content display image 220.

A modified example of a content display image 220-1 is schematically exemplified in FIG. 4. Referring to FIG. 4, in an embodiment, a chat window 227 may be included in the content display image 220-1. In this case, the chat window 27 may mean a graphic interface that displays a chat room in which a receiver who input an accurate answer and a transmitter are participants. In an embodiment, a chat room entry guideline window 226 may be included in the content display image 220-1. Further, a content display window 222 may be included in the content display image 220-1. In an embodiment, when an answer input to the question solution image 210 through the receiver terminal 1200 is determined as being accurate, a token may be issued to the receiver terminal. Further, a chat room may be set up by creating a chat session using a token of a transmitter and a token of a receiver terminal. Meanwhile, the content display window 222 may be left as a blank. That is, even though a specific content is shared, only the chat window 227 may be shared. Further, in this embodiment, only the chat window 227 is included and the content display window 222 may not be included in the content display image 220.

According to the embodiment, an entertainer creates a question-answer link by combining a question and an answer that only the entertainer and his/her huge fans can know, and opens the question-answer link to the public, whereby a chat room that the entertainer and the huge fans participate in can be created and on-line fan meeting can simply proceed. Accordingly, fan meeting can proceed without huge fans of the entertainer separately joining the membership through a service server or providing their individual identification information such as a phone number to the server, and in this respect, it could be understood that convenience or accessibility in use can be remarkably improved in comparison to the related art.

Further, an embodiment of the present disclosure can also be used for youtubers or newspapermen to communicate with readers. For example, the question-answer link described above is inserted into a content such as a predetermined news and an article, a user who opens the content can connect with the question-answer link and go on with a question solution process, and a user who input a correct answer intended by the creator of the question-answer link can communicate with the creator of the content or a person concerned on line through a chat room. Using this method, a creator of a question-answer link can selectively and easily keep communicating with only users who have predetermined culture and common sense, so it is possible to get active communication while reducing damage due to trolls by thoughtless anti-fans or senseless people.

Further, an embodiment of the present disclosure an be used for marketing. For example, in order to share a predetermined content with users entered a concert place, a user who creates a question-answer link may set a radius of 30 m around the concert place as a question and an answer In this case, when a user connecting with the question-answer link is positioned within the radius of 30 m around the concert place, the user can read the content. Accordingly, it is possible to increase the consumer's desire to participate in the concert, so it can be usefully used as a publicity strategy of the concert and a fan service strategy.

A question-answer-based content sharing system 1000 according to an embodiment of the present disclosure may include a transmitter terminal 1100, a receiver terminal 1200, and a server 1300.

In an embodiment, the server 1300 may include a controller 1310, a user interface 1320 that provides a transmitter and a receiver with a graphic user interface (GUI), and a database 1330 storing data.

In an embodiment, the controller 1310 may include a correct answer checker 1315.

In an embodiment the correct answer checker 1315 can perform a function of determining whether an answer input by a receiver is a correct answer.

In an embodiment, the correct answer checker 1315 may include a password checking module 1315a, location information checking module 1315b, a time information checking module 1315c, a period information checking module 1315d, a sound information checking module 1315e, a sound-language conversion module 1315f, a payment information checking module 1315g, a text information checking module 1315h, a handwriting input module 1315i, an image-language conversion module 1315j, a color information checking module 1315k, an exercise information checking module 1315m, a number-of-time information checking module 1315n, a member check-in checking module 1315p, etc.

In an embodiment, the user interface 1320 may include a transmitter terminal GUI creator 1323 and a receiver terminal GUI creator 1325.

In an embodiment, the database 1330 may include a content DB 1331, a question-answer DB 1333, and a user information DB 1335.

When a matter input through the transmitter terminal GUI 100 displayed on the transmitter terminal 1100 by a transmitter is received to the server 1300, the controller 1310 can store the received question, answer, and content in the database 1330.

In an embodiment, the content and the question-answer information may be separated and stored in the content DB 1331 and the question-answer DB 1333, respectively. However, even in this case, the content and the question-answer information can be separately stored with matching or link maintained.

Meanwhile, when a content is created and stored in the server 1300, the receiver terminal GUI creator 1325 can create a receiver terminal GUI 100.

In an embodiment, information that is handled in a question and an answer may be at least one selected from a password, location information, time information, period information, sound information, action information, temperature information, brightness information, input information, payment information, text information, handwriting, color information, image information, number-of-time of-time information, and member check-in information.

In an embodiment, the information that is handled in a question and an answer may be a password, and only when a receiver inputs the password set as an answer by a transmitter, the input is considered as a correct answer and a content can be displayed. In this case, the password checking module 1315a can perform a function of checking whether a password input as an answer through the receiver terminal 1200 coincides with a preset question. To this end, a storage unit that stores a password input through the transmitter terminal 1100 may be included in the password checking module 1315a. In an embodiment, an unlocking pattern may be used instead of a password. That is, a question and an answer may be a predetermined pattern, and when a swipe pattern input through the receiver terminal 1200 coincides with a preset answer, it can be considered that a correct answer is confirmed.

Further, when information that is handled by a question and an answer is location information, a correct answer is confirmed and the entire content can be displayed only when the receiver terminal 1200 is positioned at a predetermined location designated by a transmitter. In another embodiment, when location information that is input through the receiver terminal 1200 rather than the location of the receiver terminal 1200 itself coincides with location information of a preset answer, it may be admitted that the information that is handled by a question and an answer is formed. In an embodiment, the location information checking module 1315b can perform a function of checking whether location information input through the receiver 1200 terminal coincides with location information in a predetermined question-answer. To this end, a unit enabling location information to be input in the transmitter terminal 1100 and a unit for storing input location information may be included in the location information checking module 1315b. Further, a unit that receives location information through the receiver terminal 1200 and determines whether the input location information coincides with stored location information may be included in the location information checking module 1315b.

Further, when the information that is handled by a question and an answer is time information, a correct answer is confirmed and the entire content can be displayed when predetermined time (e.g., a predetermined date or a predetermined time) designated by a transmitter is reached. In this case, the time information checking module 1315c can perform a function of checking whether time information input through the receiver terminal 1200 coincides with the time information of a preset answer. To this end, a unit enabling time information to be input in the transmitter terminal 1100 and a unit for storing input time information may be included in the time information checking module 1315c. Further, a unit that receives time information through the receiver terminal 1200 and determines whether the input time information coincides with stored time information may be included in the time information checking module 1315c.

Further, when the information that is handled by a question and an answer is period information, a correct answer is confirmed and the entire content can be displayed when a predetermined period designated by a transmitter elapses. In this case, the period information may be used as an expiration date at which a message is deleted or checking a correct answer is impossible. For example, when the information handled by a question and an answer is not formed within the period designated by a transmitter, the content may be deleted. In this case, the period information checking module 1315d can perform a function of checking whether a period information input through the receiver terminal 1200 coincides with a preset answer. Meanwhile, the period information may be used as extinction condition of a content. For example, period information is set as 1 month, so a content can be read in 1 month or can be deleted in 1 month, and the later is the case in which the period information is used as an extinction condition.

Further, a question and an answer may be set as various items of information such as sound information defined as predetermined music or sound signal, action information such as a gesture or a movement distance, temperature information, brightness information such as illuminance, and pressure information such as atmospheric pressure. In this case, the sound information checking module 1315e may include a unit for storing sound information designated by a transmitter. Further, the sound information checking module 1315e can perform a function of determining whether sound information input by a receiver is matched with stored sound information by comparing the items of information.

According to an embodiment of the present disclosure, the user interface 1320 may provide the transmitter terminal GUI 100. In this case, the transmitter terminal 1100 may be connected to the server 1300 through the transmitter terminal GUI 100. In an embodiment, the user interface 1320 may operated with the correct answer checker 1315.

In an embodiment, at least one of a location information input window, a time input window, a period input window, a sound information input window, an action information input window, a temperature information input window, a brightness information input window, a pressure information input window, and a payment information input window may be included in the transmitter terminal GUI 100.

In an embodiment, the location information input window can provide information such as a map, coordinates, a place name, a store name, an address, and a phone number with a geographical location, and when a user such as a transmitter selects a specific area, the location information input window can provide a code matched with the location information of the selected area.

In an embodiment, a time input window or a period input window can perform a function of enabling a transmitter to conveniently perform a process of setting time or a period. For example, by including an interface in which a calendar or a clock is displayed, it is possible to reduce inconvenience or miss typing that may occur in the process in which a transmitter directly type time information or period information.

In an embodiment, the sound information input window can output a selectable sound information list and can provide a code matched with sound information selected by a transmitter. In this case, a sound information database may be included in the server 1300. Further, the correct answer checker 1315 may be operated with the sound information database. Meanwhile, a sound file, various songs, various kinds of music, various effect sounds, etc. recorded by a transmitted or a receiver may be stored in the sound information database. In an embodiment, a file itself including sound information may be stored in the sound information database. In another embodiment, a link that can stream various songs or music files stored in a separate server 1300 may be stored in the sound information database.

In an embodiment, the action information input window, the temperature information input window, the brightness information input window, and the pressure information input window each can provide a code matched with information selected by a transmitter. In this case, a database in which each information is stored may be included in the server 1300. Further, the correct answer checker 1315 may be operated with the database.

In an embodiment, a location information input module 1327a and a payment information input module 1327b may be further included in the user interface 1320. The location information input module 1327a may be operated with the location information input window and the payment information input module 1327b may be operated with the controller 1310 when a question-answer type is charged item payment or target amount payment.

Meanwhile, a plurality of question-answer types may be combined and used under an AND condition or an OR condition. Further, it may be possible to set one of several combined question-answer types as an extinction condition. When an extinction condition is set in this way and a correct answer keeps not being confirmed, the extinction condition is satisfied is checked, and when the extinction condition is satisfied, a content may be deleted such that it is no longer read. Further, processing according to satisfaction of an extinction condition may proceed regardless of whether it is a correct answer.

In an embodiment, a question-answer link may be implemented in a text type, a QR code type, a barcode type, etc., and can be simply copied or read out, so convenience or expansion in use is high. Further, a copied question-answer link can be applied to anything on line such as a chat program, an email, a board, and an SNS, and can improve convenience in use and expansion of a use range of a content. In addition, a QR code including a question-answer link is attached to an offline environment such as a card, a postcard, and a building so that it is possible to easily access the content connected with the question-answer link. In this case, when the question-answer link is exposed, anyone can access the link, but it is impossible to use the content when not hitting the answer of a question, so a transmitter can adjust the exposure range or exposure condition of a content in various ways. As a result, it is possible to effectively control the process of reading a content, so problems due to indiscreet opening of a content, disadvantages of a content creator due to illegal distribution of a content, or the like can be reduced.

Further, even in a situation in which a reception target is unclear or many unspecified individuals like in an SNS or a common website, a transmitter can propose a certain matter that he/she has being sharing in a question-answer type so that only users who solve the problem can read or share the content. For example, when there is a content that a user wants to share with only elementary schoolmates, the user gives a question of guessing the nickname of the user in elementary school, and the content is shared by only people who guess right the nickname. Accordingly, it is possible to expect that the content will be shared within the range of users whom the transmitter estimated regardless of whether a common web board is used or it proceeds without an opening range set on an acquaintance-based SNS.

Further, it is possible to enhance privacy and induce fun or curiosity in an information transmission process. In particular, a receiver has to guess a transmitter on the basis of limited information such as a content and has to guess the correct answer to a question set by a transmitter, so the receiver can have en experience similar to a puzzle game, a detective game, or the like. Accordingly, a game element is added to a communication tool that simply sends and receives information, so it can be used as a sensitive information transmission means or a more joyful information transmission means that could not be covered by existing communication tools.

Further, it is possible to provide a communication method, which can strengthen the ties between entertainers or sports stars and fans, and make a profit.

Although representative embodiments of the present disclosure were described above, those skilled in the art will understand that the embodiments may be modified in various ways without departing from the scope of the present disclosure. Therefore, the scope of the present invention should not be limited to the embodiment(s), but should be determined by not only the following claims, but equivalents of the claims.

An embodiment of the present disclosure can be used in industrial fields such as a content share service, a social network service, and entertainment management service.

1. A question-answer-based content sharing method comprising:
a first step of inputting and storing a question, an answer, and a content in a server through a question-answer creation image included in a transmitter terminal GUI;
a second step of creating a web page including an answer input window and a question solution image in which the question input in the first step is displayed;
a third step of creating a question-answer link connected with a web page address created in the second step;
a fourth step of opening the question-answer link created in the third step;
a fifth step of displaying the question solution image on a receiver terminal GUI connecting with the question-answer link opened in the fourth step; and
a sixth step of outputting the content input in the first step to the receiver terminal GUI when an answer input in the question solution image displayed in the fifth step coincides with the answer input in the first step.

2. The question-answer-based content sharing method of claim 1, wherein the receiver is a user who did not provide individual identification information to a service of the server.

3. The question-answer-based content sharing method of claim 2, wherein the transmitter is a user who provided individual identification information to a service of the server.

4. The question-answer-based content sharing method of claim 2, wherein a chat window is displayed on the receiver terminal GUI in the sixth step, and
the chat window displays a chat room in which a transmitter who created a question-answer link using the transmitter terminal GUI and a receiver who input a correct answer using the receiver terminal GUI are participants.

5. The question-answer-based content sharing method of claim 4, wherein when the receiver inputs a correct answer, a toke is issued to a receiver terminal, and the chat room is set up by creating a chat session using a token of the transmitter and a token of the receiver terminal.

6. The question-answer-based content sharing method of claim 2, wherein a comment window is displayed on the receiver terminal GUI in the sixth step, and
a transmitter who created a question-answer link using the transmitter terminal GUI and a receiver who input a correct answer using the receiver terminal GUI can input a comment in the comment window.

7. A question-answer-based content sharing method comprising:
a first step of inputting and storing a question, an answer, and a content in a server through a question-answer creation image included in a transmitter terminal GUI;
a second step of creating a web page including an answer input window and a question solution image in which the question input in the first step is displayed;
a third step of creating a question-answer link connected with a web page address created in the second step;
a fourth step of opening the question-answer link created in the third step;
a fifth step of displaying the question solution image on a receiver terminal GUI connecting with the question-answer link opened in the fourth step; and
a sixth step of outputting the content input in the first step to the receiver terminal GUI when an answer input in the question solution image displayed in the fifth step coincides with the answer input in the first step,
wherein the receiver is a non-member who didn't join a service of the server and the transmitter is a member who joined the service of the server.

8. The question-answer-based content sharing method of claim 1, wherein the question-answer link is input and opened in an operating service of at least one service selected from a common web board service, a social network service, and a messenger service.

9. The question-answer-based content sharing method of claim 1, further comprising a step of setting a range of the opening in the fourth step.

10. The question-answer-based content sharing method of claim 1, wherein the server includes at least one or more of a password checking module, location information checking module, a time information checking module, a period information checking module, a sound information checking module, a sound-language conversion module, a payment information checking module, a text information checking module, a handwriting input module, an image-language conversion module, a color information checking module, an exercise information checking module, and a number-of-time information checking module.

11. The question-answer-based content sharing method of claim 1, wherein the question and answer type includes at least one type of a simple text type, a location range type, a charged item payment type, a handwriting input type, an App download request type, an objective selection type, and a target payment amount satisfaction type,
the question and answer type includes a predetermined website membership joining option, and
the server determines whether login to the predetermined website succeeded.

12. The question-answer-based content sharing method of claim 1, wherein the question-answer link is converted into a QR code, the QR code is attached to at least one of a card, a target, a table, and a building, and the receiver terminal decodes the QR code and accesses the receiver terminal GUI.

13. The question-answer-based content sharing method of claim 1, wherein the question and answer type includes at least one type of a simple text type, a location range type, a charged item payment type, a handwriting input type, an App download request type, an objective selection type, and a target payment amount satisfaction type,
the question and answer type includes an N-time order-of-receipt option, and
the server stops opening the content after a correct answer to the question is confirmed N times.

14. A question-answer-based content sharing system that performing the question-answer-based content sharing method of claim 1, the question-answer-based content sharing system includes:
a transmitter terminal connected to the server through a transmitter terminal GUI;
a receiver terminal connected to the server through a receiver terminal GUI; and
a correct answer checker configured to check whether an answer that is input in the question solution image is a correct answer.

15. The question-answer-based content sharing system of claim 14, wherein the correct answer checker includes a number-of-time information checking module configured to detect whether a correct answer to the question was confirmed N times, and the server stops opening the content after a correct answer to the question is confirmed N times.
